(19) United States
(12) Patent Application Publication
(10) Pub. No.: US 2006/0165127 A1
(43) Pub. Date: Jul. 27, 2006

(54) System and method for broadband network communication through operational natural gas infrastructures

(76) Inventor: Patrick O'Neal Nunally, Escondido, CA (US)

Correspondence Address: Patrick Nunally, 2227 Villa Verde Road, Escondido, CA, 92029, US

(21) Appl. No.: 11/040,795

(22) Filed: Jan. 24, 2005

(51) Int. Cl. H04J 1/00

(52) U.S. Cl. 370/480

(57) ABSTRACT

The present invention generally relates to ultra-wideband communications. More particularly, the invention concerns a method of broadband communication by transceiving ultra-wideband signals through an active local underground natural gas distribution network such as a local or regional piping system.

### FIELD OF THE INVENTION

The present invention generally relates to ultra-wideband communications. More particularly, the invention concerns a method of broadband communication by transceiving ultra-wideband signals through an active local underground natural gas distribution network such as a local or regional piping system.

### BACKGROUND OF THE INVENTION

The Information Age is upon us. Access to vast quantities of information through a variety of different communication systems is changing the way people work, entertain themselves, and communicate with each other. For example, as a result of increased telecommunications competition mapped out by Congress in the 1996 Telecommunications Reform Act, traditional cable television program providers have evolved into full-service providers of advanced video, voice and data services for homes and businesses. A number of competing cable companies now offer cable systems that deliver all of the just-described services via a single broadband network.

These services have increased the need for bandwidth, which is the amount of data transmitted or received per unit time. More bandwidth has become increasingly important, as the size of data transmissions has continually grown. Applications such as in-home movies-on-demand, high definition television and video teleconferencing demand high data transmission rates. Another example is interactive video in homes and offices.

Other industries are also placing bandwidth demands on Internet service providers, and other data providers. For example, hospitals transmit images of X-rays and CAT scans to remotely located physicians. Such transmissions require significant bandwidth to transmit the large data files in a reasonable amount of time. These large data files, as well as the large data files that provide real-time home video are simply too large to be feasibly transmitted without an increase in system bandwidth. The need for more bandwidth is evidenced by user complaints of slow Internet access and dropped data links that are symptomatic of network overload.

Internet service providers, cable television networks and other data providers generally employ conductive wires and cables to transmit and receive data. Conventional approaches to signal (i.e. data) transmission through a transmission medium, such as a wire or cable, is to modulate the signal though the medium at a frequency that lies within the bounds at which the medium can electrically conduct the signal. Because of this conventional approach, the bandwidth of a specific medium is limited to a spectrum within which the medium is able to electrically transmit the signal via modulation, which yields a current flow. As a result, many costly and complicated schemes have been developed to increase the bandwidth in conventional conductive wire and/or cable systems using sophisticated switching schemes or signal time-sharing arrangements. Each of these methods is rendered costly and complex in part because the data transmission systems adhere to the conventional acceptance that the bandwidth of a wire or cable is constrained by its conductive properties.

Wireless methods are also employed but tend to be constrained by the Federal Communications Commission (FCC) either in power or spectral licensing costs.

Therefore, there exists a need for a more efficient system and method of providing broadband communications services which does not require costly routing of copper or fiber optic connections across the “last-mile” of communication nor requires the use of wireless spectrum transmissions which are seriously constrained by regulatory limitations.

### SUMMARY OF THE INVENTION

The present invention provides a communication system and method in which ultra-wideband signals are employed to transmit information through an active natural gas medium, where the medium is contained within as piping system, specifically a natural gas distribution system.

In one embodiment of the invention, a method of transceiving broadband signals is provided where ultra-wideband communications comprise the transmission format of the data signal such that the signal can be provided at a relatively high power level while not generating substantial heat (thus not igniting the natural gas within the gas line distribution network) and not radiating spectral energy sufficient to interfere with FCC requirements (augmented by the fact that gas lines generally must be burred to a known depth within most communities (hence are inherently shielded by ground—literally). This method of last mile broadband communication involves the steps of providing a local in situ natural gas pipeline distribution medium with a transmitting receiving or preferably transceiving an ultra-wideband signal across the pipeline medium which is representative of broadband data as well as error correction, packet headers and other information used to facilitate the network communication to a one, a plurality or a multiplicity of other transceiving located at other points on the same contiguous gas-line distribution network. Another embodiment of the present invention comprises a method of increasing a bandwidth of a community access television network, or any other type of network, by combining a multiplicity of ultra-wideband signals representative of data with the natural gas utility delivery. The combined services delivery comprising the multiplicity of ultra-wideband signals representative of data and the natural gas utility delivery is received and the two services are then separated into the multiplicity of ultra-wideband signals representative of network information and the utility delivery of natural gas.

One feature of the present invention is that an ultra-wideband signal can be transmitted simultaneously with a traditional natural gas utility delivery where such a signal can bear any combination of Internet, video, television, HDTV, voice or other transmission signal. Because the ultra-wideband signal can be transmitted substantially with the gas delivery services and be provided over existing steal or plastic piping the overall capability of the system to deliver value (i.e., gas delivery and connectivity) without requiring costly last mile deployments and without interfering with licensed and unlicensed spectrum enables a previously unobtainable level of connectivity.

### BRIEF DESCRIPTION OF THE DRAWINGS

FIG. 1 is an illustration of different communication methods;

FIG. 2 is an illustration of two ultra-wideband pulses;

FIG. 3 is a schematic illustration of one embodiment of an ultra-wideband communication system employing a piped medium; and

FIG. 4 is a schematic illustration of a second embodiment of an ultra-wideband communication system employing a piped medium.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Generally, a traditional cable television provider, a community antenna television provider, a community access television provider, a cable television provider, a hybrid fiber-coax television provider, an Internet service provider, or any other provider of television, audio, voice and/or Internet data receives broadcast signals at a central station, either from terrestrial cables, and/or from one or more antennas that receive signals from a communications satellite. The broadcast signals are then distributed, usually by coaxial and/or fiber optic cable, from the central station to nodes located in business or residential areas.

For example, community access television provider (CATV) networks are currently deployed in several different topologies and configurations. The most common configurations found today are analog signals transmitted over coaxial cable and Hybrid Fiber-Coax Systems (HFCS) that employ both fiber optic and coaxial cables. The analog coax systems are typically characterized as pure analog systems. Pure analog CATV systems are characterized by their use of established NTSC/PAL (National Television Standards Committee/Phase Alternation Line) modulation onto a frequency carrier at 6 or 8 MHz intervals.

HFCS is a combination analog—digital topology employing both coaxial (analog) and fiber optic (digital) media that typically supports digitally modulated/encoded television channels above channel 78. According to ANSI/EIA-542-1997, in the United States, the analog channels are modulated in 6 MHz allocations on channels 2 to 78 using frequencies from 55 to 547 MHz. When using HFCS, digital channels typically start at channel 79 and go as high as 136 and occupy a frequency range from 553 to 865 MHz. In some extended HFCS systems, channel assignments can go as high as channel 158 or 997 MHz. The current ANSI/EIA-542-1997 standard only defines and assigns channels to these limits. The actual wire/cable media itself is generally capable of transmitting frequencies up to 3 GHz.

In both CATV and HFCS systems, typically the satellite downlink enters the cable company's head-end and the video, and/or other data streams are de-multiplexed out. Individual video data streams (either NTSC, MPEG, or any other suitable protocol) are extracted from the satellite downlink stream and routed to modulators specific for individual television channels. The outputs from each modulator are then combined into one broadband signal. From this point the combined channels are amplified and sent out, either by coaxial or fiber optic cable, to the customers.

In a HFCS, before the combined broadband signal leaves the head-end the broadband signal is modulated onto a fiber optic cable for distribution into the field, such as residential neighborhoods, or business districts. Modulation of the broadband signal is typically accomplished in one of two ways. In the first method the entire broadband signal is sampled and digitized using a high speed Analog to Digital Converter (ADC). To perform reliable digital sampling, the data must be sampled at a rate at least twice the highest frequency component to meet Nyquist minimum sampling requirements. To provide a higher quality data stream, the signal should be sampled at 2.5 to 4 times the highest frequency, which entails sample rates of approximately 2 to 4 GHz. A parallel to serial converter then shifts the parallel output data of the ADC into a serial format. The serial data then drives a laser diode for transmission over the fiber optic cable. The second method is broadband block conversion where the entire spectrum of the broadband signal is modulated onto the fiber optic cable.

Designated access nodes are located in neighborhoods, business districts and other areas. The access nodes contain a high speed Digital to Analog Converter (DAC) and a de-serializer. A fiber optic receiver detects the laser-modulated signal at the access node. A parallel to serial converter de-serializes the data and it is feed to the high speed DAC. The data then leaves the access node on standard 75 ohm, RG-6 or RG-8 or other suitable coax cable and is distributed to the customer's premises. Thus, at the access node, the broadband signal is extracted from the fiber optic cable and transferred to a coaxial cable that connects to individual homes, apartments, businesses, universities, and other customers. Support of multiple customers is generally accomplished by the use of distribution boxes in the field, for example, on telephone poles or at ground level. However, as the signal is continuously split at the distribution boxes, the received bandwidth is reduced and the quality of the signal is diminished, thereby diminishing the video, audio, and other data quality.

The digital channels that generally reside on CATV channels 79 and higher are fundamentally different than the analog channels that generally reside on channels 2 through 78. The analog channels are comprised of modulated frequency carriers. The digital channels, which generally use the 6 MHz allocation system, are digitally modulated using Quadrature Amplitude Modulation (QAM). QAM is a method of combining two amplitude modulated signals into a single channel, thereby doubling the effective bandwidth. In a QAM signal, there are two carriers, each having the same frequency but differing in phase by 90 degrees. The two modulated carriers are combined for transmission, and separated after transmission. QAM 16 transmits 16 bits per signal, QAM 32, 64, and 256 each transmit 32, 54 and 256 bits per signal, respectively. QAM was developed to support additional video streams encoded with MPEG video compression. Conventional CATV and HFCS networks may employ QAM levels up to QAM 64 to enable up to 8 independent, substantially simultaneous MPEG video streams to be transmitted.

At the customer's location, the coaxial cable is connected to either a set-top box or directly to a television. The receiving device then de-multiplexes and de-modulates the video, audio, voice, Internet or other data. Although a television can directly receive the analog signal, a set-top box is generally required for reception of the digitally encoded channels residing on CATV channels 79 and higher.

The above-described networks, and other networks and communication systems that employ natural gas line media, such as twisted-pair or coaxial cable, suffer from performance limitations caused by signal interference, ambient noise, and spurious noise. In these conventional natural gas line media systems, these limitations affect the available system bandwidth, distance, and carrying capacity of the system, because the noise floor and signal interference in the piped media rapidly overcome the signal transmitted. Therefore, noise within the natural gas line media significantly limits the available bandwidth of any communication system or network.

Generally, the conventional wisdom for overcoming this limitation is to boost the power (i.e., increase the voltage of the signal) at the transmitter to boost the voltage level of the signal relative to the noise at the receiver. Without boosting the power at the transmitter, the receiver is unable to separate the noise from the desired signal. Thus, the overall performance of natural gas line media systems is still significantly limited by the accompanying noise that is inherent in natural gas line media.

Increasing the bandwidth of communication without employing costly natural gas line or fiber optic connectivity to the home/business, while coexisting with the conventional natural gas utility delivery system, represents an opportunity to leverage the existing unutilized transmission media network infrastructure to enable the delivery of greater functionality.

The present invention may be employed in any type of natural gas delivery segment that uses buried or shielded pipe to deliver natural gas, in whole, or in part. That is, this inventions resultant network may use pipeline transmission segments media, such as steel or plastic pipe, and no fewer that one of the following: natural gas line, optical, wireless, or satellite networks. As defined herein, a network is a group of points or nodes connected by communication paths. The communication paths may be connected by wires, or they may be wirelessly connected however at leaser one segment must utilize a wireless connection transmitted within a underground or shielded natural gas line. A network as defined herein can interconnect with other networks and contain subnetworks. A network as defined herein can be characterized in terms of a spatial distance, for example, such as a local area network (LAN), a metropolitan area network (MAN), and a wide area network (WAN), among others. A network as defined herein can also be characterized by the type of data transmission technology in use on it, for example, a TCP/IP network, and a Systems Network Architecture network, among others. A network as defined herein can also be characterized by whether it carries voice, data, or both kinds of signals. A network as defined herein can also be characterized by who can use the network, for example, a public switched telephone network (PSTN), other types of public networks, and a private network (such as within a single room or home), among others. A network as defined herein can also be characterized by the usual nature of its connections, for example, a dial-up network, a switched network, a dedicated network, and a nonswitched network, among others. A network as defined herein can also be characterized by the types of physical links that it employs, for example wireless in gas line and any one of the following optical fiber, coaxial cable, a mix of both, unshielded twisted pair, and shielded twisted pair, among others.

The present invention employs a “carrier free” architecture which does not require the use of high frequency carrier generation hardware, carrier modulation hardware, stabilizers, frequency and phase discrimination hardware or other devices employed in conventional frequency domain communication systems. The present invention dramatically increases the bandwidth of conventional last mile natural gas line and wireless networks that employ natural gas line, optical or in air wireless media, but can be inexpensively deployed without extensive modification to the existing natural gas delivery networks.

The present invention provides increased bandwidth by injecting, or otherwise super-imposing an ultra-wideband (UWB) signal into the existing natural gas delivery systems and subsequently recovers the UWB signal at an end node, set-top box, subscriber gateway, or other suitable location resident on the same contiguous natural gas line. Ultra-wideband, or impulse radio, employs pulses of electromagnetic energy that are emitted at nanosecond or picosecond intervals (generally tens of picoseconds to a few nanoseconds in duration). For this reason, ultra-wideband is often called “impulse radio.” Because the excitation pulse is not a modulated waveform, UWB has also been termed “carrier-free” in that no apparent carrier frequency is evident in the radio frequency (RF) spectrum. That is, the UWB pulses are transmitted without modulation onto a sine wave carrier frequency, in contrast with conventional radio frequency technology. Ultra-wideband requires neither an assigned frequency nor a power amplifier.

Conventional radio frequency technology employs continuous sine waves that are transmitted with data embedded in the modulation of the sine waves' amplitude or frequency. For example, a conventional cellular phone must operate at a particular frequency band of a particular width in the total frequency spectrum. Specifically, in the United States, the Federal Communications Commission has allocated cellular phone communications in the 800 to 900 MHz band. Cellular phone operators use 25 MHz of the allocated band to transmit cellular phone signals, and another 25 MHz of the allocated band to receive cellular phone signals.

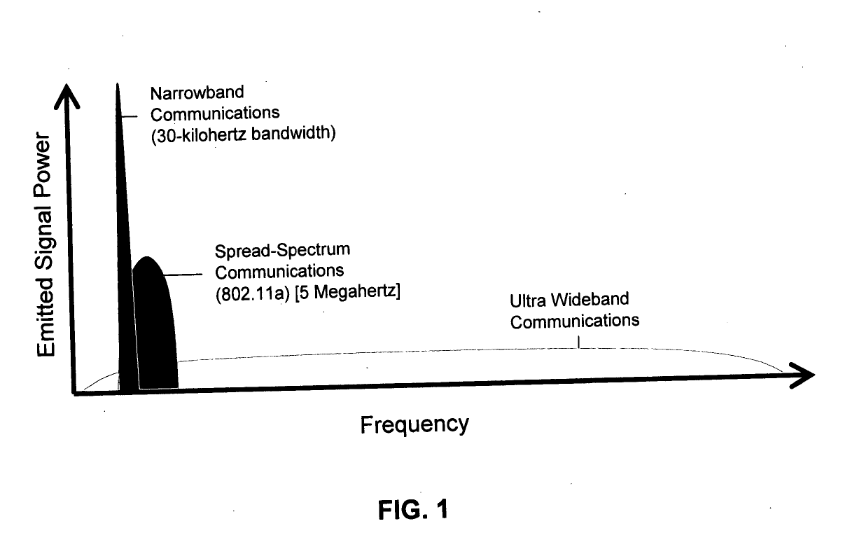

Another example of a conventional radio frequency technology is illustrated in FIG. 1. 802.11a, a wireless local area network (LAN) protocol, transmits radio frequency signals at a 5 GHz center frequency, with a radio frequency spread of about 5 MHz.

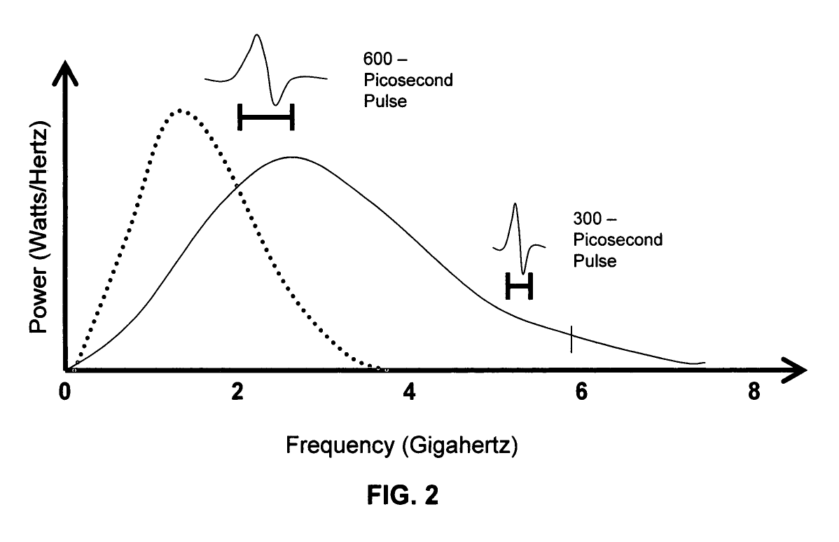

In contrast; a UWB pulse may have a 1.8 GHz center frequency, with a frequency spread of approximately 4 GHz, as shown in FIG. 2, which illustrates two typical UWB pulses. FIG. 2 illustrates that the narrower the UWB pulse in time, the higher its center frequency and the broader the spread of its frequency spectrum. This is because frequency is inversely proportional to the time duration of the pulse. A 600 picosecond UWB pulse will have about a 1.8 GHz center frequency, with a frequency spread of approximately 4 GHz. And a 300 picosecond UWB pulse will have about a 3 GHz center frequency, with a frequency spread of approximately 8 GHz. Thus, UWB pulses generally do not operate within a specific frequency, as shown in FIG. 1. And because UWB pulses are spread across an extremely wide frequency range, UWB communication systems allow communications at very high data rates, such as 100 megabits per second or greater.

Further details of UWB technology are disclosed in U.S. Pat. No. 3,728,632 (in the name of Gerald F. Ross, and titled: Transmission and Reception System for Generating and Receiving Base-Band Duration Pulse Signals without Distortion for Short Base-Band Pulse Communication System), Which is referred to and incorporated herein in its entirety by this reference.

Also, because the UWB pulse is spread across an extremely wide frequency range, the power sampled at a single, or specific frequency is very low. For example, a UWB one-watt signal of one nano-second duration spreads the one-watt over the entire frequency occupied by the pulse. At any single frequency, such as at the carrier frequency of a CATV provider, the UWB pulse power present is one nano-watt (for a frequency band of 1 GHz). This is well within the noise floor of any piped media system and therefore does not interfere with the demodulation and recovery of the original CATV signals. Generally, the multiplicity of UWB pulses are transmitted at relatively low power (when sampled at a single, or specific frequency), for example, at less than −30 power decibels to −60 power decibels, which minimizes interference with conventional radio frequencies. However, UWB pulses transmitted through most burred or shielded natural gas lines will not interfere with wireless radio frequency transmissions. Therefore, the power (sampled at a single frequency) of UWB pulses transmitted though piped media may range from about +100 dB to about −90 dB.

For example, a CATV system generally employs a coaxial cable that transmits analog data on a frequency carrier. Generally, amplitude modulation (AM) or QAM (discussed above) are used to transmit the analog data. Since data transmission employs either AM or QAM, UWB signals can coexist in this environment without interference. In AM, the data signal M(t) is multiplied with a cosine at the carrier frequency. The resultant signal y(t) can be represented by:
y(t)=m(t)cos(ω_{c}t)

In a QAM based system multiple carrier signals are transmitted at the same carrier frequency, but at different phases. This allows multiple data signals to be simultaneously carried. In the case of two carriers, an “in phase” and “quadrature” carriers can carry data signals Mc(t) and Ms(t). The resultant signal y(t) can be represented as:
y(t)=m_{c}(t)cos(ω_{c}t)+mₛ(t)sin(ω_{c}t)

However, as discussed above, an UWB system transmits a narrow time domain pulse, and the signal power is generally evenly spread over the entire bandwidth occupied by the signal. At any instantaneous frequency, such as at the AM or QAM carrier frequency, the UWB pulse power present is one nano-watt (for a frequency band of 1 GHz). This is well within the noise floor of any gas line distribution network system and therefore does not interfere with the demodulation and recovery of the original AM or QAM data signals.

Traditional natural gas line and wireless network systems suffer from performance limitations caused by signal interference, ambient noise, and spurious noise. These limitations affect the available bandwidth, distance, and carrying capacity of the network system. With the network described in this invention (burred or shielded gas line communication systems) the noise floor and outside signal interference in the gas line is virtually zero. This low noise on the gas line network is a significant advantage to the ability of the system to increase bandwidth. UWB technology makes use of the noise floor to transmit data, without interfering with the injection of a concentrated power carrier signal. Moreover, UWB transmitted through a gas line network has distinct advantages over its use in a wireless environment. In a gas line network environment there are no concerns with intersymbol interference, and there are no concerns relating to multi-user interference.

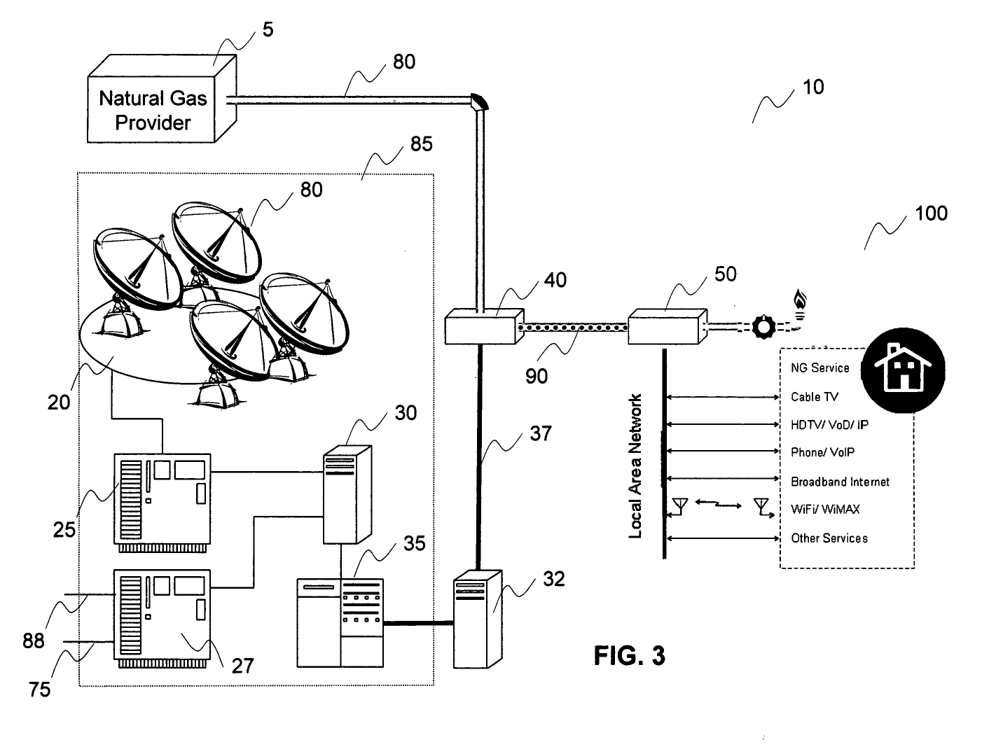

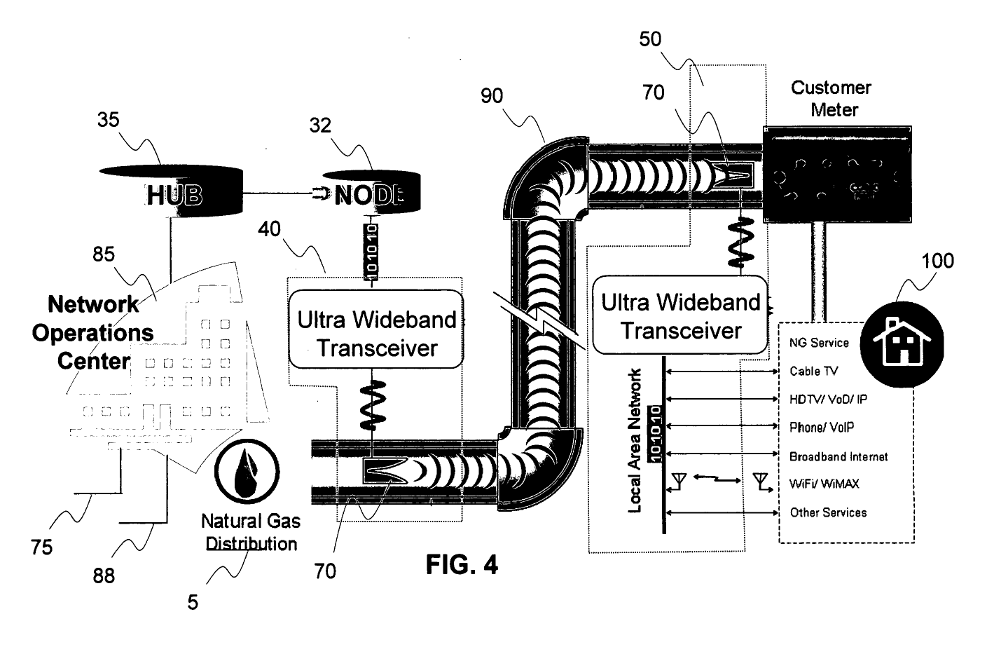

The present invention provides an apparatus and method to enable any gas line network to augment their available service by delivering broadband services simultaneously with natural gas delivery. Preferably, this bandwidth is delivered by introducing UWB signals into the existing natural gas delivery chain prior and routed via node and hub architecture in to network operations center (NOC) which acts as a broadcast system operator's head-end, tier one internet connection phone network interface. As shown in FIGS. 3 and 4, the NOC may include several components, such as the antenna farm 15, the satellite receivers 20, the channel modulator 25, the combiner 30, and the fiber optic transmitter/receiver 35. Alternatively, UWB signals may be introduced into the gas line distribution network at a plurality of locations, such as at the local distribution line 90 or at the gas main 80, or at any other suitable location.

In like fashion, network system operators can receive more data from individual subscribers by introducing subscriber-generated data into existing contiguous gas line. The present invention provides UWB communication across natural gas distribution networks and will be able to both transmit and receive digital information for the purposes of telephony, high-speed data, video distribution, video conferencing, wireless base operations and other similar purposes.

Referring to FIG. 3, the ultra-wideband communication within natural gas line system 10 is configured to transmit ultra-wideband signals through an gas distribution network or system that includes steel, plastic or other pipe types. For example, the piped ultra-wideband (UWB) system 10 may transmit UWB signals through an existing or regional gas utility, which my be public, private, state, interstate or federal natural gas lines and may connect to an optical network, a cable television network, a community antenna television network, a hybrid fiber-coax television network, an Internet service provider network, a PSTN network, a WAN, LAN, MAN, TCP/IP network, a college campus, town, city, or any other type of network as defined above, that employs at leas one leg of gas line connectivity in whole or in part.

One embodiment of the natural gas UWB communication system 10 is illustrated in FIG. 3. An antenna farm 15 receives audio, video and data information from one or more satellites (not shown). Additional data may be received by terrestrial cables and wires, and by terrestrial wireless sources, such as a multichannel multipoint distribution service (MMDS) 27. The satellite data is then forwarded to the satellite receivers 20 that demodulate the data into separate audio, video and data streams. This information is forwarded to the channel modulators that receive the program signals, such as CNN or MTV. The channel modulators 25 mix each signal with a radio frequency (RF) and assign a station number (such as 2 to 99) that each program will be received on by subscribers.

The multiple RF signals are then forwarded to a combiner that combines the multiple signals into a single output. That is, the combiner 30 receives the program signals from the channel modulators 25 and/or 27 and combines them onto a single coax cable and forwards the signal to the fiber optic transmitter/receiver 35. The above-described arrangement and function of channel modulators 25, 27 and combiners 30 may vary with each type of network.

Additional audio, video, or other data signals received from either the antenna farm 15 or from terrestrial sources such as fiber optic or coaxial cables can be routed from the network operation center 20 to the local area ultra-wideband (UWB) broadcast device 40. The gas utility provider UWB device 40 converts the audio, video, or other data signals received from the network receiver 20 into a multiplicity of UWB electromagnetic pulses which are broadcast through the local natural gas filled pipe. The natural gas utility provider ultra-wideband (UWB) device 40 may include several components, including a controller, digital signal processor, an analog coder/decoder, one or more devices for data access management, and associated cabling and electronics. The service provider ultra-wideband (UWB) device 40 may include some, or all of these components, other necessary components, or their equivalents. The controller may include error control, and data compression functions. The analog coder/decoder may include an analog to digital conversion function and vice versa. The data access management device (or devices) may include various interface functions for interfacing to traditional networks such as wireless, phone, optical, coaxial and other network technologies.

The digital signal processor in the utility service provider ultra-wideband (UWB) device 40 modulates the audio, video, or other data signals received from the network 37 into a multiplicity of UWB electromagnetic pulses, and may also demodulate UWB pulses received from the subscriber. As defined herein, modulation is the specific technique used to encode the audio, video, or other data into a multiplicity of UWB pulses. For example, the digital signal processor may modulate the received audio, video, or other data signals into a multiplicity of UWB pulses that may have a duration that may range between about 0.1 nanoseconds to about 100 nanoseconds, and may be transmitted at relatively high power, for example, at more than +100 power decibels to −60 power decibels, as measured across the transmitted frequency.

The UWB pulse duration and transmitted power may vary, depending on several factors. Different modulation techniques employ different UWB pulse timing, durations and power levels. The present invention envisions several different techniques and methods to transmit an UWB signal across a natural gas line. One embodiment, may for example, use pulse position modulation that varies the timing of the transmission of the UWB pulses. One example of a pulse position modulation system may transmit approximately 10,000 pulses per second. This system may transmit groups of pulses 100 picoseconds early or 100 picoseconds late to signify a specific digital bit, such as a “0” or a “1”. In this fashion a large amount of data may be transmitted across a natural gas line.

An alternative modulation technique may use pulse amplitude modulation to transmit the UWB signal across a natural gas line. Pulse amplitude modulation employs pulses of different amplitude to transmit data. Pulses of different amplitude may be assigned different digital representations of “0” or “1.” Other envisioned modulation techniques include On-Off Keying that encodes data bits as pulse (1) or no pulse (0), and Binary Phase-Shift Keying (BPSK), or bi-phase modulation. BPSK modulates the phase of the signal (0 degrees or 180 degrees), instead of modulating the position. Spectral Keying, which is neither a PPM nor PAM modulation technique, may also be employed. It will be appreciated that other modulation techniques, currently existing or yet to be conceived, may also be employed.

A preferred modulation technique will optimize signal coexistence and pulse reliability by controlling transmission power, pulse envelope shape and Pulse Recurrent Frequencies (PRF). Both pseudo-random and fixed PRFs may be used, with the knowledge that a fixed PRF may create a “carrier-like frequency,” which it and its higher order harmonics may interfere with the data carried in conventional RF carrier channels. However, with a pseudo-random PRF the difficulties encountered with a fixed PRF are usually avoided. One embodiment of a pseudo-random PRF modulation technique may include a UWB pulse envelope that is shaped by a process to distortion mapping to pre-condition and compensate for multi-path, distortion, interference frequency components that the natural gas line may naturally introduce or attenuate. UWB pulse conditioning for the given natural gas line has the additional advantage of controlling the power spectral density of the transmitted data stream.

Several advantages exist when transmitting UWB pulses through natural gas line as opposed to transmitting UWB pulses through the air in a traditional free space wireless medium. Free space wireless UWB transmissions must consider such issues as Inter-Symbol Interference (ISI) and Multi-User Interference (MUI), regulatory power constraints all of which can severely limit the bandwidth of UWB transmissions. Some modulation techniques such as Pulse Amplitude Modulation (PAM), which offer the ability for high bit densities are not effective at long wireless distances. These, and other issues, do not apply to UWB pulses transmitted through natural gas lines. In addition, no variable multipath issues arise and there are no unpredictable propagation delay problems present in a natural gas line network. Therefore, it is estimated that an ultra-wideband system may be able to transmit data across a natural gas line network in a range from 100 Mbit/second to 10 Gbit/second. This data rate will ensure that the bandwidth requirements of any service provider can be met.

A preferred embodiment of the service-provider UWB device 40 will spread the signal energy of the UWB data stream across the a bandwidth that may range from 10 Hz to approximately 1 GHz or as discussed above, to 10 GHz, or higher. This will ensure that the signal energy present at any frequency is significantly below the thermal limit of the natural gas line ensuring coexistence with conventional natural gas delivery.

For example, a UWB pulse would have a duration of about 1 nano-second in a UWB data stream that has a 1 GHz bandwidth. Alternatively, the UWB pulse duration would be tailored to match the full frequency of a natural gas line network. A narrow pulse width is preferred because more pulses can be transmitted in a discrete amount of time. Pulse widths of up to 2 nano-seconds may be employed to guarantee pulse integrity throughout digitization, transmission, reception and reformation at the UWB subscriber device 50. Generally, an idealized pulse width would be calculated based on the frequency response of the specific natural gas line system.

Referring to FIG. 3, the multiplicity of generated UWB pulses are sent from the utility service-provider 5 to the combiner 30, which combines the UWB pulses with the natural gas distribution 90. One method to accomplish this task is to insert an antenna 70 carrying the UWB signals to a standard local natural gas main directed toward the points of natural gas consumption. The UWB transceiver 40 placed within the gas main gathers and provides data forwarded to and from the network operations center via fiber optic transmitter/receiver 35. The fiber optic transmitter/receiver 35 converts the multiplicity of UWB transcevied pulses received from the natural gas line network 30 into a corresponding optical signal. The gas signal generator can be either a antenna placed within the active gas line, an antenna placed at a plastic elbow joint such that the signal is radiated into the pipeline or other suitable configuration. The UWB signal is then distributed through the active gas lines to residential neighborhoods, business districts, universities, colleges or other locations for distribution to subscribers and customers 100. Other methods and techniques for combining a UWB pulse stream and an active (or decommissioned) gas lines may also be employed. For example, the UWB pulse stream may be sent to a network hub 32, which will then transceive the network signals.

Shown in FIG. 3, a fiber multiplexer node 40 may be located at any one of the locations described above. The optical signals are received by the multiplexer 40 and are converted into the UWB pulsed signals. The combined UWB signals and natural gas are forwarded to a subscriber UWB device located at the subscriber location 50. The subscriber UWB device 50 can be considered a gateway or router that provides access to the UWB signals cared by the natural gas line.

One embodiment of the subscriber UWB device 50 will demodulate the multiplicity of UWB electromagnetic pulses back into a conventional RF carrier signal. The subscriber UWB device 50 may include all, some or additional components found in the service provider UWB device 40. In this manner, additional bandwidth will be available to the natural gas line network to provide the additional data and functionality demanded by the customer.

An alternative embodiment of the present invention is illustrated in FIG. 4. A full service natural gas line UWB communication system 90 is structured to allow for extremely high data rate transmission of video, telephone, internet and audio signals.

The full service UWB system 90 receives audio, video and data information from an antenna farm 15 or from terrestrial sources such as fiber optic or coaxial cables. These signals are forwarded to the gas main transceivers 40 as described above with reference to the natural gas line UWB communication system 10. In addition, signals from a public telephone network 75 are received by a host digital terminal 85. The host digital terminal 80 modulates multiple voice signals into two-way upstream and downstream RF signals. The voice signals from the host digital terminal 85 are forwarded to the gas main UWB device 40.

An internet service provider 88 forwards internet data to the internet router 27. The internet router 27 generates packets, such as TCP/IP packets, which are forwarded to the gas main UWB transceivers 40.

The gas main UWB transceiver UWB device 40 modulates the internet data, the telephony data and the video data into a multiplicity of electromagnetic pulses, as described above, and forwards the pulses the transmitter/receiver 35.

The combined services (broadband and natural gas) are forwarded to a subscriber UWB device 50 and gas service. The subscriber UWB device 50 can be considered a gateway or router that provides access to the UWB signals. The subscriber UWB device 50 demodulates the multiplicity of UWB electromagnetic pulses into RF signals and forwards the RF signals to appropriate locations such as televisions, personal computers or telephones. Alternative embodiment subscriber UWB devices 50 may be connected wirelessly to televisions sets similar to a set-top box and used to transmit on-demand movies, internet access or pay-per-view programs. Yet another embodiment of the present invention may include a UWB device 50 that may be via local area network to a television set, phone or computer. The UWB device 50 is constructed to convert and distribute data to computers, network servers, digital or subscription televisions, interactive media devices such as set-top boxes and telephone switching equipment.

The subscriber UWB device 50 may also be configured to transmit UWB pulses wirelessly to provide audio, video, and other data content to personal computers, televisions, PDAs, telephones and other devices. For example, UWB device 50 may include the necessary components to transmit and receive UWB or conventional RF carrier signals to provide access to interfaces such as PCI, PCMCIA, USB, Ethernet, IEEE1394, or other interface standards.

The present invention will also allow for data to be transmitted “upstream” toward the service provider. For example, a UWB transmission is coded so as not to interfere with upstream traffic. These codes also serve the purpose of limiting access to the data transmission.

The present invention of transmitting ultra-wideband signals across a natural gas line can employ any type of piped media. For example, the piped media can include plastic, steel, iron, rigid, flexible, valved and metered. This type of piping is most commonly used for delivering natural gas over long and short distances. The foregoing list of pipe media is meant to be exemplary, and not exclusive.

As described above, the present invention can provide additional bandwidth to enable the transmission of large amounts of data over an existing natural gas distribution networks, whether the information carried across the natural gas line network is Internet service, television, HDTV, medical information, phone, video, or a computer network located in a business or university. The additional bandwidth can allow consumers to receive the high speed Internet access, interactive video and other features that they are demanding.

Thus, it is seen that an apparatus and method for transmitting and receiving ultra-wideband signals through an active natural gas line is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. An ultra-wideband communication system for a natural gas line network, comprising: an ultra-wideband transmitter structured to transmit an ultra-wideband signal through the natural gas line network; and an ultra-wideband receiver structured to receive the ultra-wideband signal from the natural gas line network.

2. The ultra-wideband communication system of claim 1, wherein the ultra-wideband signal comprises an impulse radio signal.

3. The ultra-wideband communication system of claim 1, wherein the ultra-wideband signal comprises a pulse of electromagnetic energy having a duration that can range between about 0.1 nanoseconds to about 100 nanoseconds.

4. The ultra-wideband communication system of claim 1, wherein the ultra-wideband signal comprises a pulse of electromagnetic energy having a duration that can range between about 0.1 nanoseconds to about 100 nanoseconds and a power that can range between about 100 power decibels to about −90 power decibels, as measured at a single frequency.

5. The ultra-wideband communication system of claim 1, wherein the ultra-wideband transmitter comprises an ultra-wideband pulse modulator that is structured to transmit a multiplicity of ultra-wideband signals.

6. The ultra-wideband communication system of claim 1, wherein the ultra-wideband receiver comprises an ultra-wideband pulse demodulator that is structured to receive a multiplicity of ultra-wideband signals.

7. The ultra-wideband communication system of claim 1, wherein a pipe employed in the natural gas line network is selected from a group consisting of: steel, plastic, iron, copper, and an gas containment material.

8. The ultra-wideband communication system of claim 1, wherein the natural gas line network is interconnected to a network selected from a group consisting of: a power line, an optical network, a cable television network, a community antenna television network, a community access television network, a hybrid fiber coax system network, a public switched telephone network, a wide area network, a local area network, a metropolitan area network, a TCP/IP network, a dial-up network, a switched network, a dedicated network, a nonswitched network, a public network and a private network.

9. A method of transmitting data through a natural gas utility distribution infrastructure, the method comprising the steps of: providing the natural gas utility distribution infrastructure; and transmitting an ultra-wideband signal through the natural gas utility distribution infrastructure.

10. The method of claim 9, wherein the natural gas utility distribution infrastructure is selected from the group consisting of: an local gas utility, a regional gas utility, a private gas distribution infrastructure, and a public gas distribution infrastructure.

11. The method of claim 9, wherein the ultra-wideband signal comprises an impulse radio signal.

12. The method of claim 9, wherein the ultra-wideband signal comprises a pulse of electromagnetic energy having a duration that can range between about 0.1 nanoseconds to about 100 nanoseconds.

13. The method of claim 9, wherein the ultra-wideband signal comprises a pulse of electromagnetic energy having a duration that can range between about 0.1 nanoseconds to about 100 nanoseconds and a power that can range between about 100 power decibels to about −90 power decibels, as measured at a single frequency.

14. The method of claim 9, wherein the ultra-wideband signal is used to transmit data selected from a group consisting of: telephony data, high-speed data, digital video data, digital television data, Internet communication data and audio data.

15. The method of claim 9, wherein the ultra-wideband signal is transmitted substantially simultaneously with natural gas utility service.

16. The method of claim 9, wherein the natural gas utility distribution service is used to transmit data selected from the group consisting of: telephony data, high-speed data, digital video data, digital television data, Internet communication data and audio data.

17. The method of claim 9, wherein the ultra-wideband signal and a natural gas utility distribution use a substantially common pathway for electromagnetic radiation spectrum and natural gas conveyance.

18. The method of claim 9, wherein the ultra-wideband signal are transmitted in a frequency band that can range from between about 1 KHz to about 10 GHz.

19. The method of claim 9, wherein the multiple ultra-wideband signals use separate portions of an electromagnetic radiation spectrum.

20. A method of providing broadband communication, the method comprising the steps of: providing natural gas utility distribution infrastructure; combining a multiplicity of ultra-wideband signals representative of data with natural gas resident in the distribution system; receiving the combined multiplicity of ultra-wideband signals representative of data and the natural gas at a point within said natural gas distribution infrastructure; and bridging the multiplicity of ultra-wideband signals representative of data and a local areas network to make use of the broadband communication.

21. The method of claim 20, wherein the ultra-wideband signals representative of data comprise a multiplicity of pulse quadrature amplitude modulated signals.

22. The method of claim 20, wherein the ultra-wideband signals representative of data comprise a multiplicity of pulse position modulated signals.

23. The method of claim 20, wherein the ultra-wideband signals representative of data comprise a multiplicity of pulse amplitude modulated signals.

24. The method of claim 20, wherein the ultra-wideband signals representative of data are modulated at a fixed pulse rate frequency.

25. The method of claim 20, wherein the ultra-wideband signals representative of data are modulated at a variable pulse rate frequency.

26. The method of claim 20, wherein the ultra-wideband signals representative of data are modulated at a pseudo-random pulse rate frequency.

27. The method of claim 20, wherein the multiplicity of ultra-wideband signals comprise an impulse radio signal.

28. The method of claim 20, wherein the multiplicity of ultra-wideband signals comprise a pulse of electromagnetic energy having a duration that can range between about 0.1 nanoseconds to about 100 nanoseconds.

29. The method of claim 20, wherein the multiplicity of ultra-wideband signals comprise a pulse of electromagnetic energy having a duration that can range between about 0.1 nanoseconds to about 100 nanoseconds and a power that can range between about 100 power decibels to about −90 power decibels, as measured at a single frequency.

30. The method of claim 20, wherein the multiplicity of ultra-wideband signals are used to transmit data selected from a group consisting of: telephony data, high-speed data, digital video data, digital television data, Internet communication data and audio data.

31. A method of transmitting and receiving data through a natural gas distribution pipeline, the method comprising the steps of: providing natural gas distribution pipeline network; combining a multiplicity of ultra-wideband signals representative of data with natural gas as it is being disseminated; receiving a combined service comprising the multiplicity of ultra-wideband signals representative of data and the natural gas service; and separating the combined signal into the multiplicity of ultra-wideband signals representative of data and the natural gas utility service.

32. The method of claim 31, wherein the multiplicity of ultra-wideband signals comprise an impulse radio signal.

33. The method of claim 31, wherein the multiplicity of ultra-wideband signals comprise a pulse of electromagnetic energy having a duration that can range between about 0.1 nanoseconds to about 100 nanoseconds.

34. The method of claim 31, wherein the multiplicity of ultra-wideband signals comprise a pulse of electromagnetic energy having a duration that can range between about 0.1 nanoseconds to about 100 nanoseconds and a power that can range between about 100 power decibels to about −90 power decibels, as measured at a single frequency.

35. The method of claim 31, wherein the multiplicity of ultra-wideband signals are used to transmit data selected from a group consisting of: telephony data, high-speed data, digital video data, digital television data, Internet communication data and audio data.

36. The method of claim 31, wherein the ultra-wideband signal is used to transmit data selected from a group consisting of: telephony data, high-speed data, digital video data, digital television data, Internet communication data and audio data.

37. The method of claim 31, wherein the ultra-wideband signal is transmitted in a frequency band that can range from between about 1 KHz to about 10 GHz.

38. The method of claim 31, wherein the ultra-wideband signal is divided by coding such that multiple data signal use substantially the same electromagnetic radiation spectrum.

39. An ultra-wideband system structured to transmit and receive data through a network that includes a natural gas line medium, the ultra-wideband system comprising: an ultra-wideband transmitter positioned at a first location on the network, the ultra-wideband transmitter structured to transmit an ultra-wideband signal through the natural gas line medium; and an ultra-wideband receiver positioned at a second location on the network, the ultra-wideband receiver structured to receive the ultra-wideband signal from the natural gas line medium.

40. The ultra-wideband system of claim 39, wherein the natural gas line network transmits and receives data bridged from a group consisting of: a power line, an optical network, a cable television network, a community antenna television network, a community access television network, a hybrid fiber coax system network, a public switched telephone network, a wide area network, a local area network, a metropolitan area network, a TCP/IP network, a dial-up network, a switched network, a dedicated network, a nonswitched network, a public network and a private network.

41. The ultra-wideband system of claim 39, wherein the ultra-wideband signal comprises an impulse radio signal.

42. The ultra-wideband system of claim 39, wherein the ultra-wideband signal comprises a pulse of electromagnetic energy having a duration that can range between about 0.1 nanoseconds to about 100 nanoseconds.

43. The ultra-wideband system of claim 39, wherein the ultra-wideband signal comprises a pulse of electromagnetic energy having a duration that can range between about 0.1 nanoseconds to about 100 nanoseconds and a power that can range between about 100 power decibels to about −90 power decibels, as measured at a single frequency.

44. The ultra-wideband system of claim 39, wherein the ultra-wideband transmitter comprises an ultra-wideband pulse modulator that is structured to transmit a multiplicity of ultra-wideband signals.

45. The ultra-wideband system of claim 39, wherein the ultra-wideband receiver comprises an ultra-wideband pulse demodulator that is structured to receive a multiplicity of ultra-wideband signals.

46. The method of claim 39, wherein the ultra-wideband signals representative of data are modulated at a fixed pulse rate frequency.

47. The method of claim 39, wherein the ultra-wideband signals representative of data are modulated at a variable pulse rate frequency.
